(19) United States
(12) Patent Application Publication
(10) Pub. No.: US 2022/0076455 A1
(43) Pub. Date: Mar. 10, 2022

(54) AUGMENTED REALITY HEAD MOUNTED DISPLAYS AND METHODS OF OPERATING THE SAME FOR INSTALLING AND TROUBLESHOOTING SYSTEMS

(71) Applicant: T-MOBILE USA, INC., Bellevue, WA (US)

(72) Inventor: Wilfred I. Tucker, Centennial, CO (US)

(21) Appl. No.: 17/015,878

(22) Filed: Sep. 9, 2020

(51) Int. Cl. G06T 11/00; G06F 3/14; G16Y 10/75; G06K 7/14; G06F 8/61

(52) U.S. Cl. CPC G06T 11/00; G06F 3/14; G06F 8/61; G06K 7/1417; G16Y 10/75

(57) ABSTRACT

Augmented reality (AR) using head mounted displays (HMDs) and methods of operating the same for installing and troubleshooting systems are disclosed. A disclosed example HMD configured to be worn by an installer includes: a display; a communication interface; a processor; and a non-transitory computer-readable medium storing computer-readable instructions. The instructions, when executed by the processor, cause the HMD to access, via the communication interface, installation status information from a component of a system at an installation site, and present, on the display, an augmented reality environment including the installation status information and real world content.

### FIELD OF THE DISCLOSURE

This disclosure relates generally to system installations and, more particularly, to augmented reality head mounted displays and methods of operating the same for installing and troubleshooting systems.

### BACKGROUND

Modern communication systems often involve multiple components, such as a set-top box (STB), a modem, a wireless router, etc., at different locations (e.g., different rooms) of an installation site. Such components may occasionally require configuration or adjustment, such as during initial installation, replacement, upgrading, or troubleshooting. When such interaction with the components is necessary or beneficial, a technician or other individual (e.g., an installer, repairer, or user of the equipment) may need to make adjustments to multiple components. Even where only one component initially requires adjustment or installation, operation or communication with the other components of the system should be verified to ensure the system is functioning correctly. Thus, if a new component (e.g., a network gateway or modem) is installed, communication with existing components should be verified to confirm each component of the system is properly configured for operation with the new component. This is currently a manual process in which the technician or other individual performs diagnostic checks on each of the components, which often requires movement between various locations or interfaces of the various components. Thus, much time is spent simply transitioning between components.

Additionally, individuals involved in such configuration or adjustment of communication systems often need to reference technical specification of the components in order to properly install or configure the components, which may depend upon the configuration of the other components of the communication system. Further time is often lost to looking up such technical data, as well as to misconfiguration as a result of using technical data intended to different combinations of components of the communication system.

### SUMMARY

Currently, when an installer installs, troubleshoots, or otherwise interacts with a system (e.g., a communication system, a media delivery system, combinations thereof, etc.) having multiple components (e.g., a STB, modem, router, media player, media recorder, switch, etc.) at different locations of an installation site (e.g., a residence, a place of business, test site, service provider site, etc.), the installer typically has to physically move back and forth between the locations and/or components to check whether the components are working as intended. Aspects of this disclosure solve, reduce or eliminate some or all of these or other problems of conventional communication system installation. For example, the problem of an installer having to physically move back and forth between the locations and/or components is solved by providing an augmented reality (AR) head mounted display (HMD) that enables a user, installer or customer to view (in some examples simultaneously with a real world view of the user's field of view) in an augmented reality fashion, the status of the components, installation information for the components, diagnostic information for the components, and configuration of the customer's system to a service provider's system, etc. from a single component. In some embodiments, the HMD provides information or instructions for proper installation, configuration, or maintenance of equipment, which may include graphical overlays. Aspects of the present disclosure may also be used during training of installers.

A disclosed example HMD configured to be worn by an installer includes: a display; a communication interface; a processor; and a non-transitory computer-readable medium storing computer-readable instructions. The instructions, when executed by the processor, cause the HMD to access, via the communication interface, first installation status information from a first component of a system at an installation site, and present, on the display, an augmented reality environment including the first installation status information and real world content.

A disclosed example method of operating an HMD includes: accessing, via a communication interface of an HMD configured to be worn by a user at an installation site, first installation status information from a first component of a communication system at an installation site; obtaining, by the HMD real world content; and presenting an augmented reality environment including the first installation status information and the real world content.

A disclosed example non-transitory computer-readable storage medium stores instructions that, when executed, cause a head mounted display (HMD) to, while being used at an installation site: access first installation status information from a first component of a communication system; and present an augmented reality environment including the first installation status information and real world content.

### BRIEF DESCRIPTION OF THE DRAWINGS

The figures described below depict various aspects of the apparatus, methods, and systems disclosed herein. It should be understood that each figure depicts an embodiment of one or more particular aspects of the disclosed apparatus, systems and methods, and that each of the figures is intended to accord with one or more possible embodiments thereof. The figures depict embodiments of this disclosure for purposes of illustration only. One skilled in the art will readily recognize from the following discussion that alternate embodiments of the apparatus, structures and methods disclosed herein may be employed without departing from the principles set forth herein. Wherever possible, the following description refers to the reference numerals included in the following figures, in which features depicted in multiple figures are designated with consistent reference numerals. The figures are not to scale.

FIG. 1 is a block diagram of an example AR based system for installing and troubleshooting communication systems, on which the HMDs and methods of operating the same described herein may operate, in accordance with disclosed aspects of this disclosure.

FIG. 2 is an example flowchart representative of example processes, methods, etc. for installing or troubleshooting a communication system using an one of the disclosed HMDs, in accordance with disclosed aspects of this disclosure.

FIG. 3 is an example AR based presentation showing component and/or system information overlaid or superimposed on real world content.

FIG. 4 is an example AR based presentation showing component and/or system information overlaid or superimposed on real world content.

FIG. 5 is an example AR based presentation showing component and/or system information overlaid or superimposed on real world content.

FIG. 6 is an example AR based presentation showing component and/or system information overlaid or superimposed on real world content.

FIG. 7 is an example AR based presentation showing component and/or system information overlaid or superimposed on real world content.

FIG. 8 is an example AR based presentation showing component and/or system information overlaid or superimposed on real world content.

FIG. 9 is an example AR based presentation showing component and/or system information overlaid or superimposed on real world content.

FIG. 10 is an example AR based presentation showing component and/or system information overlaid or superimposed on real world content.

FIG. 11 is an example AR based presentation showing component and/or system information overlaid or superimposed on real world content.

FIG. 12 is an example AR based presentation showing component and/or system information overlaid or superimposed on real world content.

FIG. 13 is an example AR based presentation showing component and/or system information overlaid or superimposed on real world content.

FIG. 14 is an example AR based presentation showing component and/or system information overlaid or superimposed on real world content.

FIG. 15 is a block diagram of an example HMD that may be used to implement the example HMD of FIG. 1, and configured for use during installation or troubleshooting of communication systems, in accordance with disclosed aspects of the invention.

### DETAILED DESCRIPTION

Reference will now be made in detail to non-limiting examples, some of which are illustrated in the accompanying drawings.

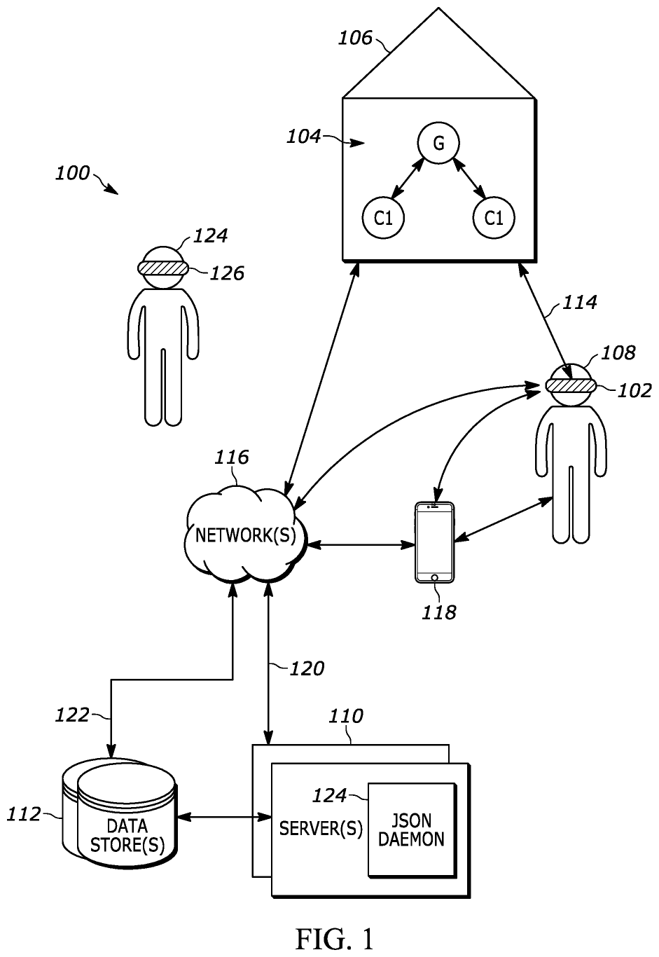

FIG. 1 is a block diagram of an example augmented reality (AR) based system 100 having any number and/or type(s) of head mounted displays (HMDs) (an example of which is designated at reference numeral 102) for use by persons installing or troubleshooting systems at installation sites. Example installations include installing or upgrading a communication system 104 at a residential installation site 106 (e.g., a home, apartment, condominium, townhome, boat, etc.), a place of business installation site, or a media-providing system (e.g., at a service provider site), combinations thereof. Although the exemplary communication system 104 is illustrated as comprising three components (i.e., a gateway G, a first component C1, and a second component C2), various configurations having additional, fewer, or alternative numbers or types of components are contemplated within the scope of the invention described herein. The AR based system 100 includes both hardware and software applications, as well as various data communications channels for communicating data between the various hardware and software components.

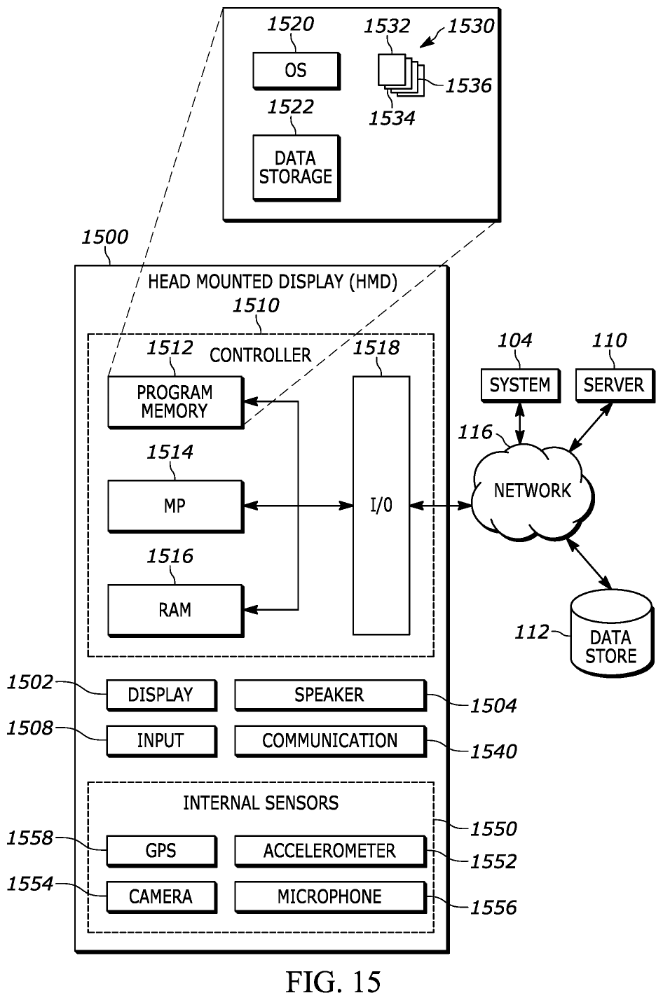

The HMD 102 may be any number and/or type(s) of wearable HMD 102 from any number and/or type(s) of manufacturers, such as Vuzix Blade® smart glasses, a visor, a pair of goggles, or a retinal projector. The HMD 102 is configured to enable a user 108, wearer, installer, etc. to interact with the HMD 102 to install, upgrade or troubleshoot components (e.g., components C1, C2, G illustrated in FIG. 1) of the communication system 104 or, more generally, to install, upgrade or troubleshoot operation of the communication system 104. For example, the user 108 may interact with the HMD 102 while initially installing and configuring the components of the communication system 104 or while adding, repairing, or replacing components of the communication system 104. In addition to interacting with components of the communication system 104, the HMD 102 is configured to enable to user 108 or, more generally, the HMD 102 to interact with any number and/or type(s) servers 110 that may communicate with the components C1, C2, G and/or any number and/or type(s) of data stores 112 to obtain or access information related to the components C1, C2, G of the communication system 104 and/or services provided to the communication system 104. The HMD 102 may communicate with the components C1, C2, G of the communication system 104, the server(s) 110, the data store(s) 112 via any number and/or type(s) of communication link(s) 114, path(s), network(s) 116, intermediary device(s) 118, communication protocol(s), data access protocol(s), etc. The HMD 102 is further discussed below in connection with FIG. 15.

The example server(s) 110 and/or the data store(s) 112 may be configured to communicate with the components C1, C2, G of the communication system 104 via any number and/or type(s) of communication link(s) 120, 122, path(s), network(s) 116, intermediary device(s), communication protocol(s), data access protocol(s), etc. to obtain, collect, access, etc. regarding the status, configuration, etc. of the components C1, C2, G. Such data may be conveyed, stored, etc., for example, as Java Script Objection Notation (JSON) data parsed in hypertext markup language (HTML) files. The server(s) 110 and/or the data store(s) 112 may be further configured to communicate, provide, convey, etc. such information to the HMD 102 via the any number and/or type(s) of communication link(s), path(s), network(s) 116, intermediary device(s) 118, communication protocol(s), data access protocol(s), etc.

Each server 110 may include one or more of any number and/or type(s) of processors (not shown for clarity of illustration) adapted and configured to execute various software applications and components of the AR based system 100, in addition to other software applications. The processor(s) communicate with the components of the communication system 104 via any number and/or type(s) of communication link(s) 120, 122, path(s), network(s) 116, communication protocol(s), data access protocol(s), etc. to obtain, collect, access, etc. regarding the status, configuration, etc. of the components. The server(s) 110 may further include a database (not shown for clarity of illustration), which may be adapted to store data (e.g., JSON data parsed in HTML files) related to the AR based system 100. Additionally and/or alternatively, the server(s) 110 may store such data in the data store(s) 112.

The communication link(s) 114 may be any number and/or type(s) of wired or wireless communication link including, but not limited, to a Wi-Fi connection, a fixed wireless connection (e.g., lower power and/or sensitivity), a Bluetooth® connection, a Bluetooth® low energy connection, a near field communication connection, a universal serial bus (USB) cable, etc.

The network(s) 116 may include a wired, wireless, cellular, satellite proprietary network, public internet, virtual private network or some other type of network, such as dedicated access lines, plain ordinary telephone lines, satellite links, cellular data networks, combinations of these, etc. Where the network(s) 116 comprises the Internet, data communications may take place over the network(s) 116 via an Internet communication protocol.

Example intermediary device(s) 118 include, but are not limited to, smartphones, tablets, laptops, notebooks, field test equipment, etc. In some examples, the HMD 102 is considered a low-capability HMD and is configured to interact with the intermediary device(s) 118 to obtain data for presentation, and relies on the intermediary device(s) 118 for communication with other devices, systems, etc., and/or for processing of data, etc. For example, the HMD 102 may be designed or configured to operate as an input/output device of a mobile computing device (e.g., a smartphone or tablet computer) acting as an intermediary device 118 to obtain, process and communicate data with the HMD 102 and/or server(s) 110.

In some examples, the AR based system 100 can include additional users 124 wearing HMDs 126. The additional users 124 and HMDs 126 can interact with the system 104 separately, or work collaboratively with the user 108 and HMD 102. The HMDs 102 and 126 can communicate directly (e.g., via Bluetooth, NFC or WiFi, etc.), or indirectly (e.g., via the gateway G, the intermediary device 118, the servers 110, etc.). In some examples, the user 124 and HMD 126 are remote from the user 108, HMD 102 and system 104. For example, remote assistance with install, debug, troubleshooting, etc. In some examples, one HMD 102, 126 can display the real world content of the other HMD 102, 126. In some examples, the HMDs 102 and 126 display the same content, for example, for use in training or collaborative install, debug, troubleshooting, etc.

The collaborative AR based system 100 described above and illustrated in FIG. 1 may be used to perform the methods discussed further below. Although the following description of example methods discusses certain aspects of the invention disclosed herein as being performed by the HMD 102 and/or a user 108 thereof, it should be understood that the example AR based system 100 may include more than one of the elements, processes and devices illustrated in FIG. 1, the elements, processes and devices may be combined, divided, re-arranged, omitted, eliminated or implemented in any other way.

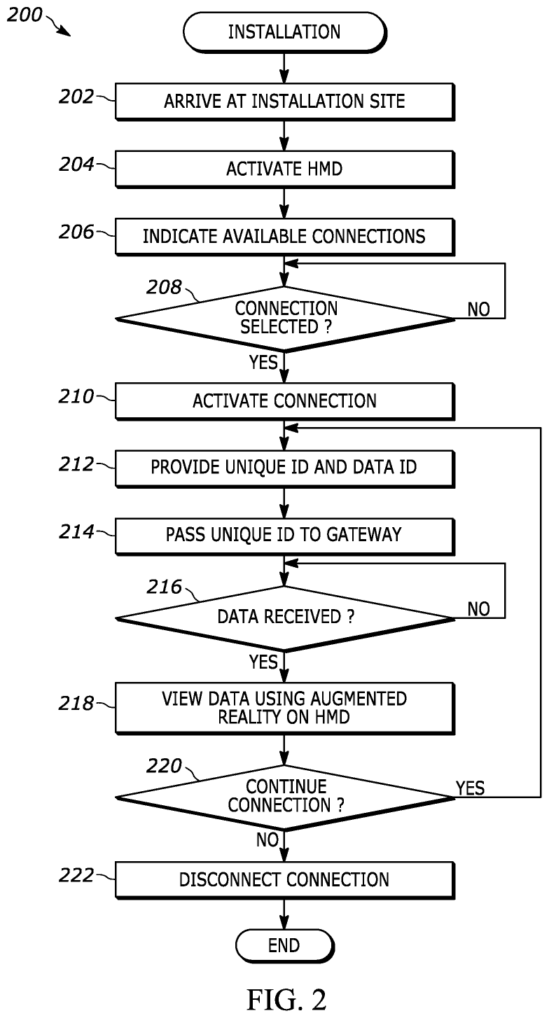

Turning to FIG. 2, a flowchart 200 representative of example processes, methods, etc. for installing or troubleshooting a communication system using one of the disclosed HMDs is shown. Although the example processes, methods, etc. are described with reference to the flowchart illustrated in FIG. 2, many other methods of installing or troubleshooting a system using an HMD may alternatively be used. For example, the order of execution of the blocks may be changed, and/or some of the blocks described may be changed, eliminated, or combined.

During the installation or troubleshooting of the communication system 104 at the installation site 106, the user 108 utilizes the HMD 102. For example, the HMD 102 may be used to display information using AR technologies. When, after the user 108 enters the installation site (block 202) and activates their HMD 102 (block 204), the HMD 102 starts scanning or listening for Bluetooth communications from components C1, C2, G of the communication system 104. The HMD 102 indicates (e.g., using an AR presentation) on its display 1502 (see FIG. 15) the component(s) C1, C2, G to which the HMD 102 can become communicatively coupled (block 206).

When the user 108 initiates a connection with one of the components C1, C2, G by activating a feature (e.g., a button, spoken command, etc.) of the HMD 102 (block 208), the HMD 102 establishes the selected connection (block 210). For example, when the gateway G is found by the HMD 102 and selected by the user 108, the HMD 102 becomes communicatively coupled with the gateway G and can then access data associated with the gateway G from the gateway G, or access data associated with any of the other components C1, C2 via the gateway G. The other components C1, C2 can communicate their data to the gateway G, or their data can be accessed remotely by the gateway G via the server(s) 110 and/or data store(s) 112. In this manner, the HMD 102 can access data from a component C1, C2, G that is not within Bluetooth range via another component C1, C2, G that is within Bluetooth range, thereby obviating the need for the user 108 to physically move from component to component during install, or troubleshooting.

To install, configure, troubleshoot, etc. a particular component such as the component C1 the user can provide an identifier (e.g., a service set identifier (SSID)) and a password for the component C1 and a type of data (e.g., configuration, troubleshooting data set #1, troubleshooting data set #2, etc.) to be obtained, accessed, etc. using an interface of the HMD 102 and/or an intermediary device 118 (block 212).

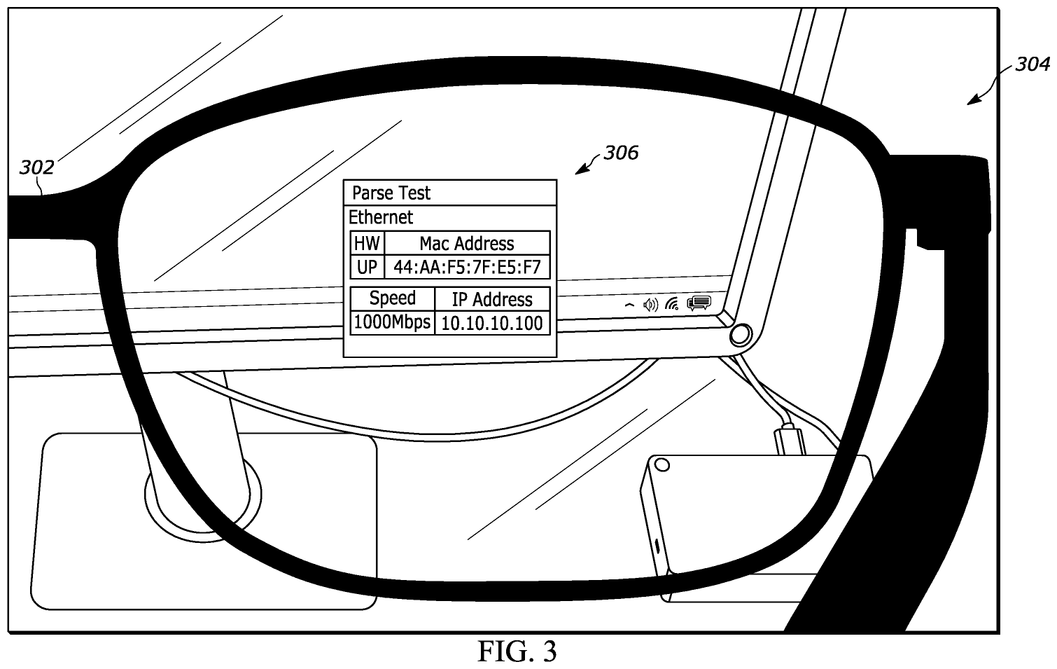

The HMD passes the identifier to the gateway G (see FIG. 1), such as a set-top box via the connected component C1, C2, G, etc. (block 214). When the requested data is received (e.g., as JSON data parsed in HTML file(s)), and transferred (e.g., using a Generic Attribute Profile (GATT) of a low-energy Bluetooth transfer, and/or a bi-directional transport using web sockets) and parsed (block 216), the user 108 can view the requested data on the HMD 102 in, for example, an AR based presentation (block 218). Example AR based presentations are shown in FIGS. 3-14 and discussed below. In some examples, the gateway G sends the JSON data parsed in HTML file(s) to the server(s) 110 and/or the data store(s) 112 for retrieval by the HMD 102 and/or the intermediary device 118 via, for example, a JSON daemon 124 (see FIG. 1) running on the server(s) 110. In some examples, the SSID is for another component C1, C2, G, etc. rather than for the component C1, C2, G, etc. to which the HMD 102 is connected, thereby, reducing the need to move physically back and forth between components. That is, a component C1, C2, G, etc. can be installed, tested and configured via a connection with another component C1, C2, G, etc., the intermediary device 118, the server(s) 110 and/or the data store(s) 112. In some examples, the SSID, configuration information for a component, or configuration information for an installation site may be visually obtained from a surface of a component, by scanning and decoding the payload of an indicia (e.g., a QR code on a component), etc.

While the user 108 continues the connection (block 220), control returns to block 212 to provide identifiers (block 212). If the connection is to end (block 220), the user 108 provides an indication to the HMD 102 to end the connection (block 222).

Example AR based presentations are shown in FIGS. 3-14. In the illustrated example of FIGS. 3-14, the user 108 is wearing an HMD 108 in the form of smart glasses 302 through which they can see real world content 304 in addition to overlaid, superimposed, etc. configuration information, data, etc. related to one or more components of a communication system and/or, more generally, the communication system. In the example of FIG. 3, parsed system configuration data 306 is overlaid, superimposed, etc. on the real world content 304. The configuration data 306 is Ethernet configuration data for an identified component C1, C2, G in the form of a MAC address, link speed and IP address.

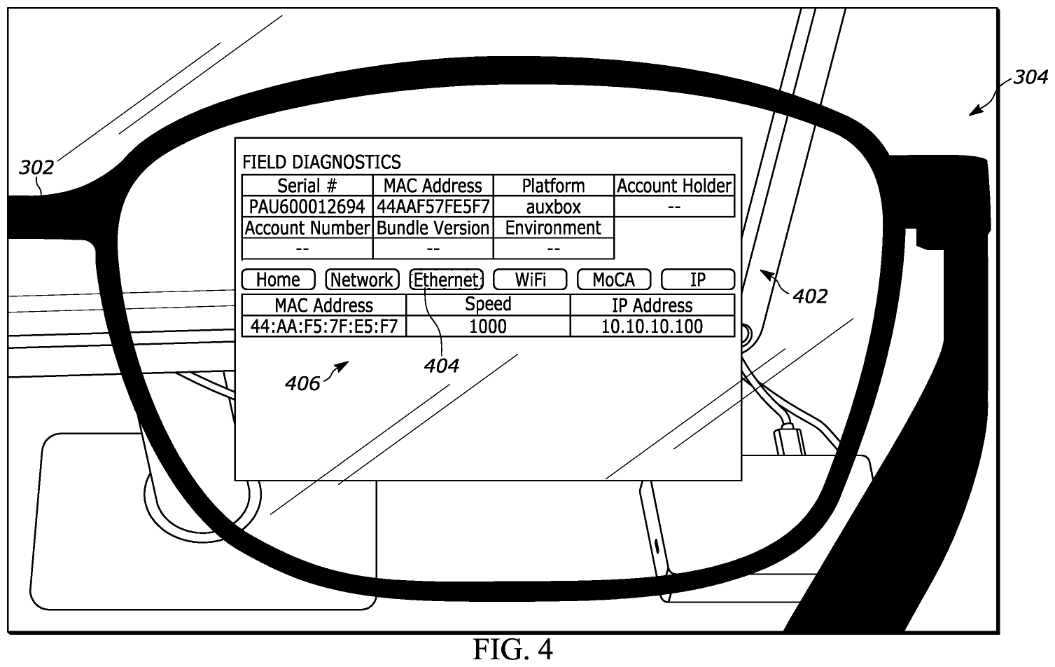

In FIGS. 4-12, different field diagnostic troubleshooting data sets are overlaid, superimposed, etc. on the real world content 304. In the example of FIG. 4, an example field diagnostics interface 402 is shown where an interface element 404 corresponding to an Ethernet interface is selected and field diagnostic troubleshooting data 406 for the Ethernet interface is shown.

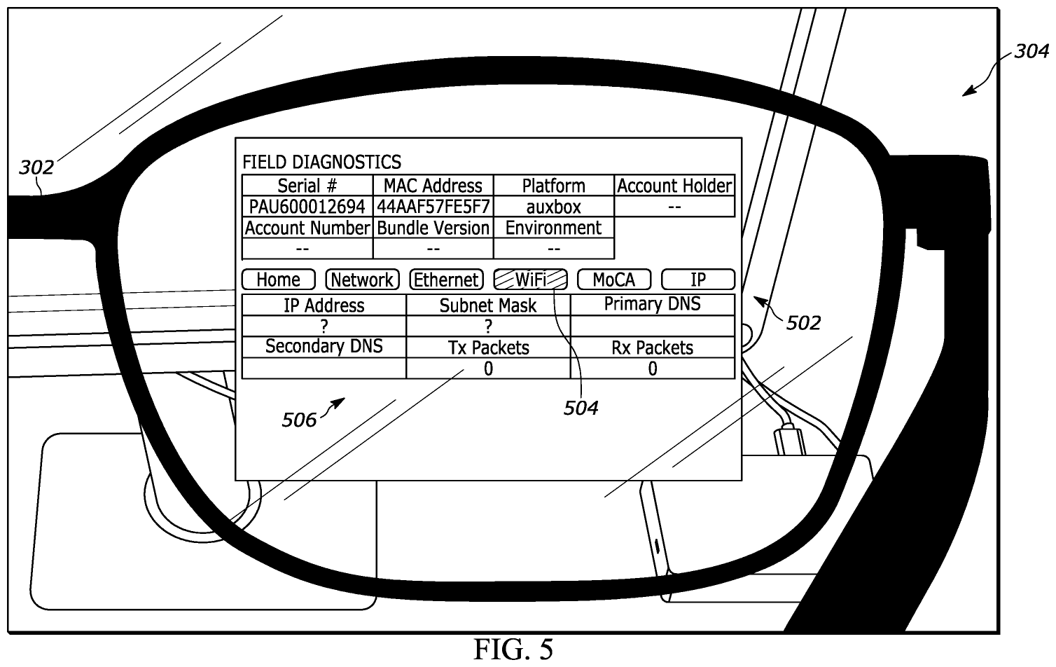

In the example of FIG. 5, an example field diagnostics interface 502 is shown where an interface element 504 corresponding to an WiFi interface is selected and field diagnostic troubleshooting data 506 for the WiFi interface is shown.

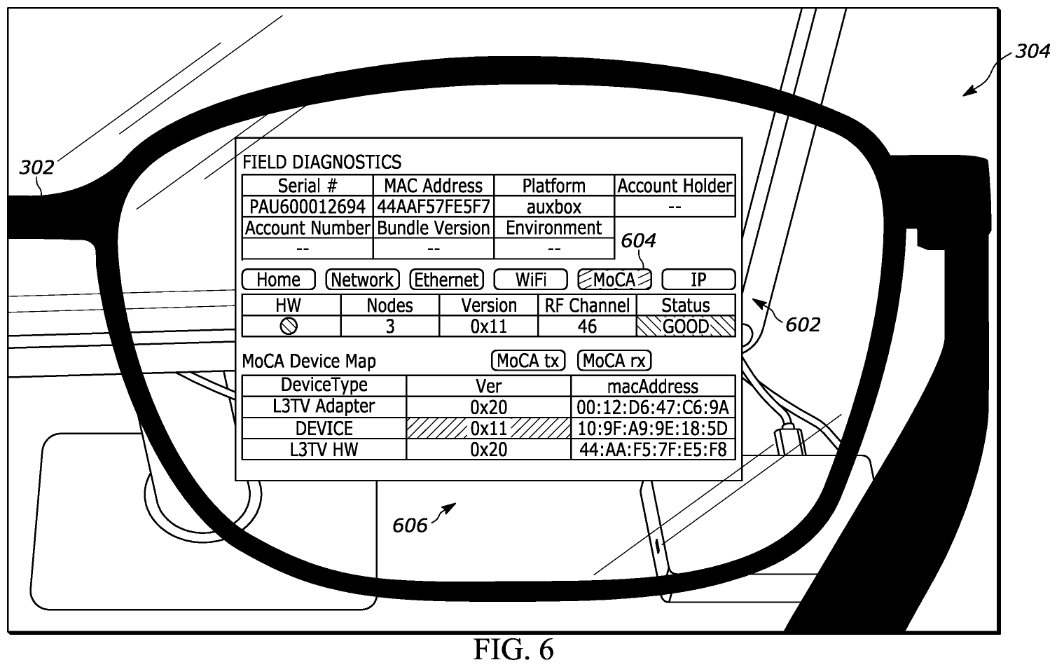

In the example of FIG. 6, an example field diagnostics interface 602 is shown where an interface element 604 corresponding to an Multimedia over Coax Alliance (MoCA) interface is selected and configuration data 606 for the MoCA interface is shown.

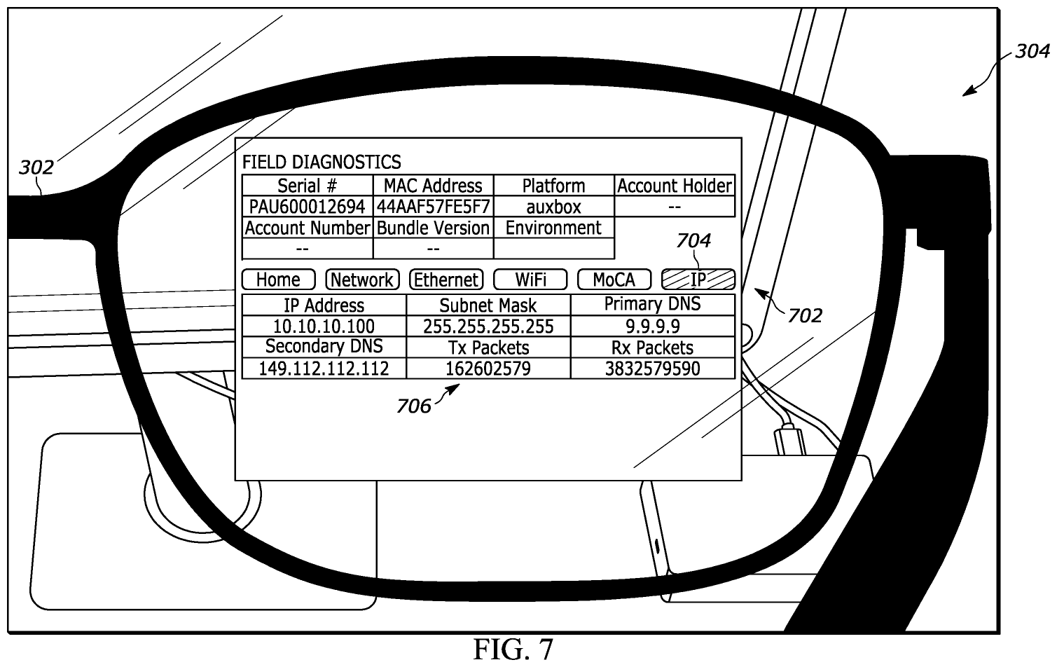

In the example of FIG. 7, an example field diagnostics interface 702 is shown where an interface element 704 corresponding to an interface is selected and configuration data 706 for the IP interface is shown.

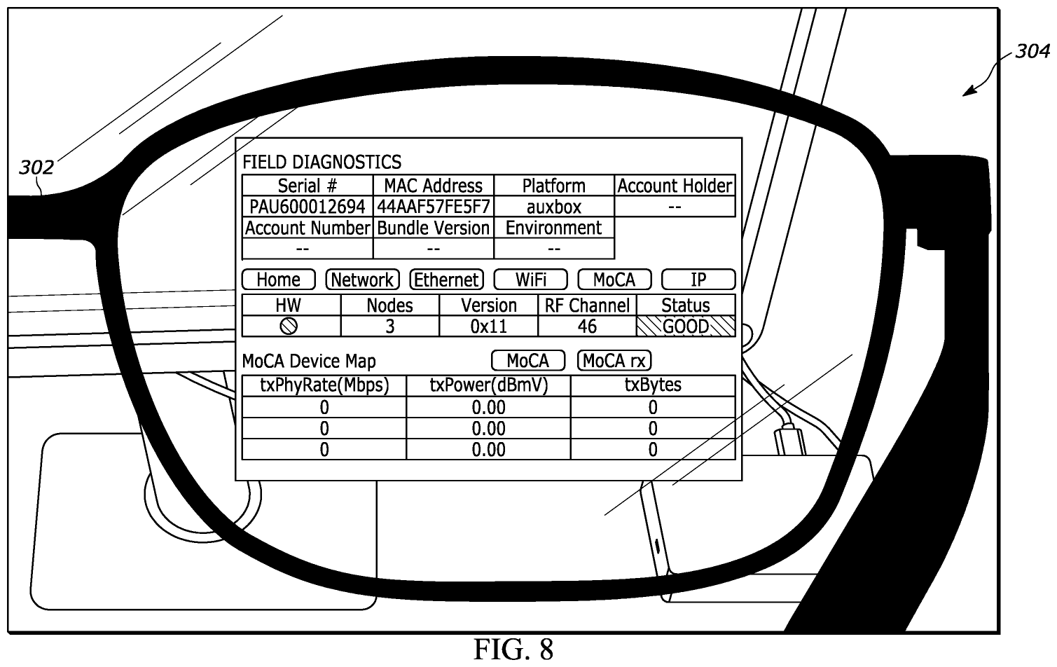

In the example of FIG. 8, an example field diagnostics interface is shown that includes an example MoCA receive interface map.

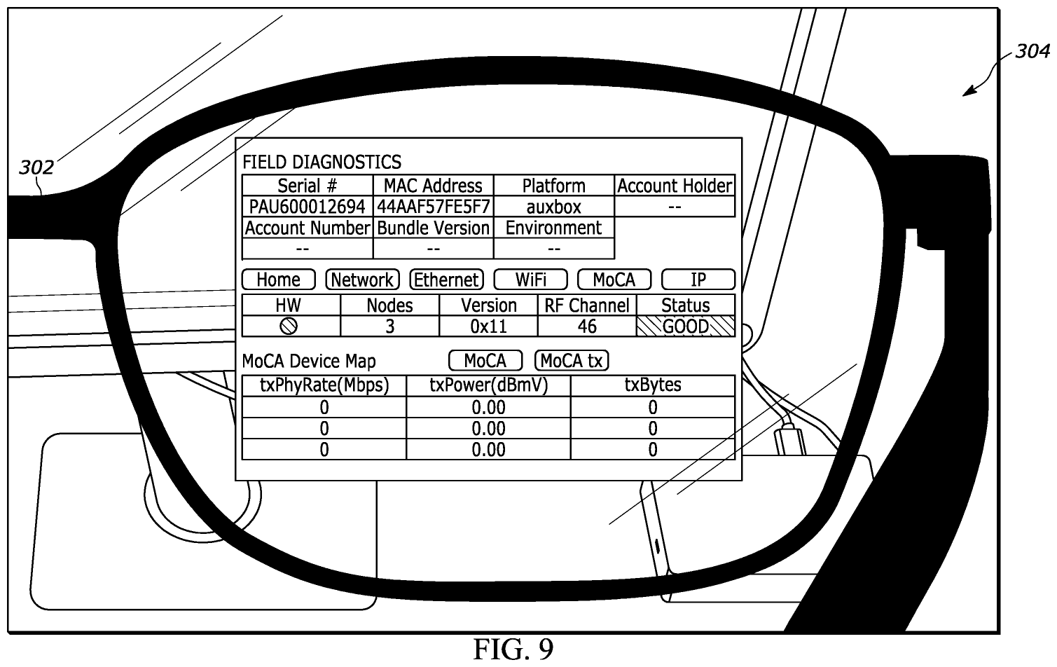

In the example of FIG. 9, an example field diagnostics interface is shown that includes an example MoCA transmit interface map.

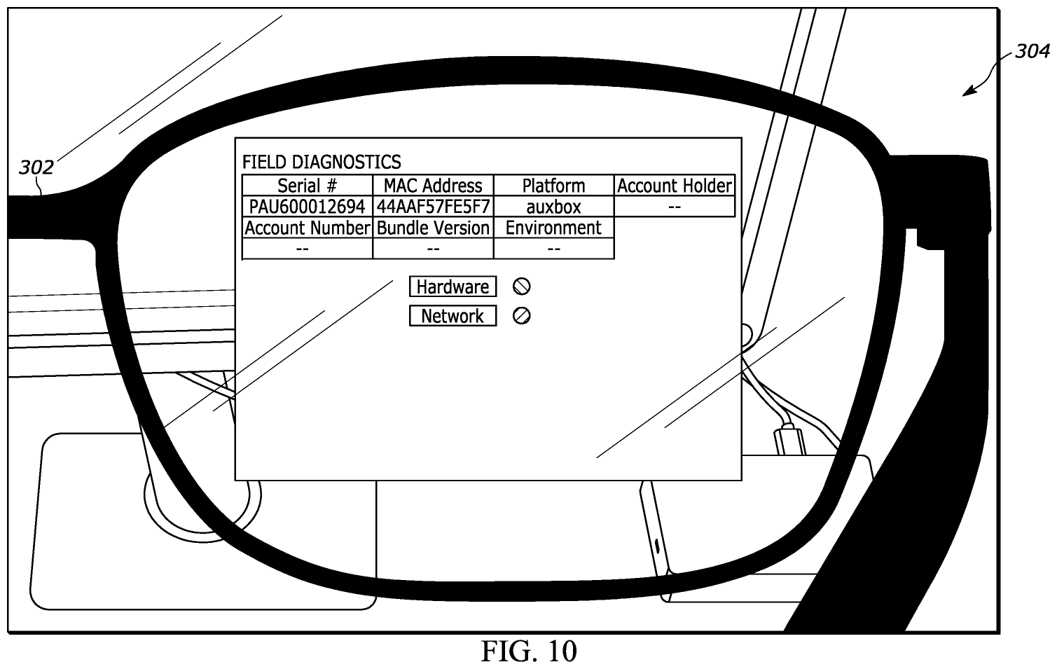

In the example of FIG. 10, an example field diagnostics interface to enable a user to select hardware or network overlaid, superimposed, etc. on the real world content 304.

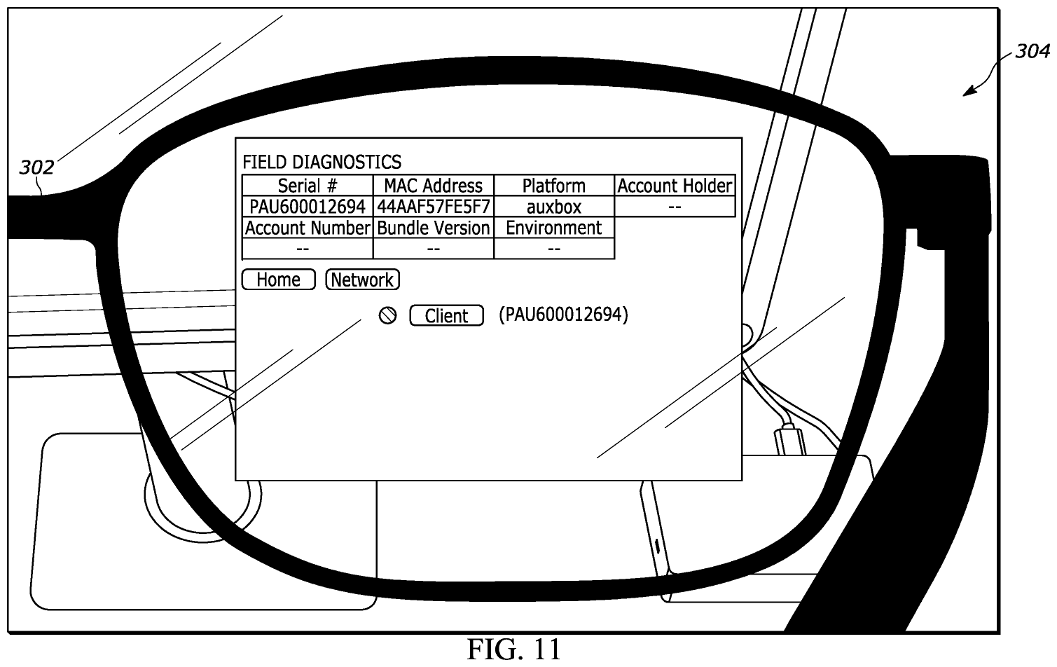

In the example of FIG. 11, an example field diagnostics interface to enable a user to select a network client overlaid, superimposed, etc. on the real world content 304.

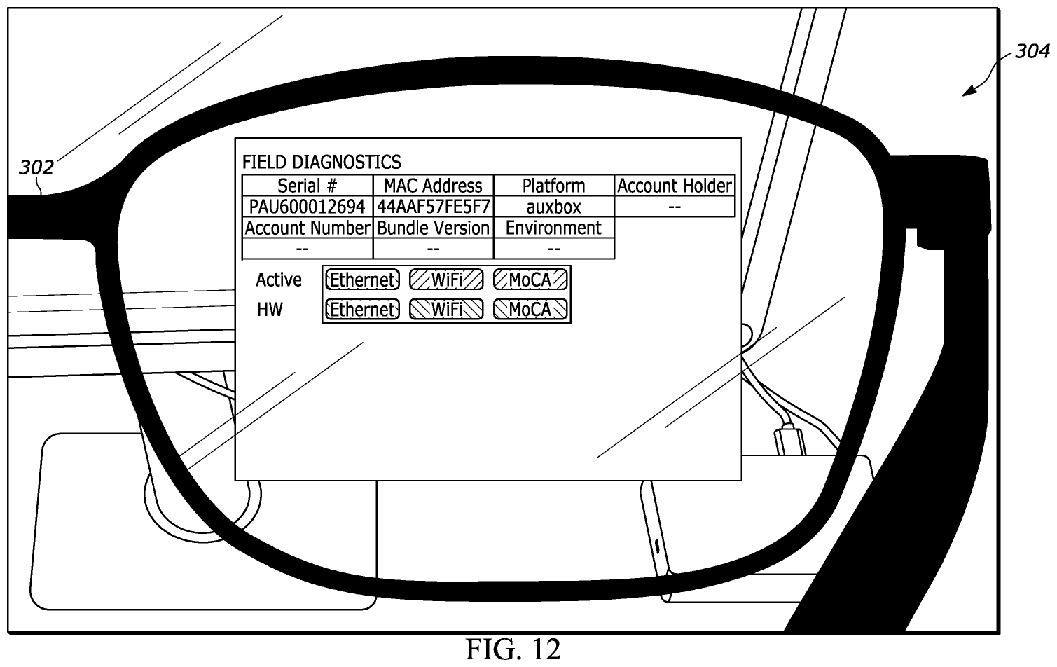

In the example of FIG. 12, an example field diagnostics interface to enable a user to select network client interface overlaid, superimposed, etc. on the real world content 304

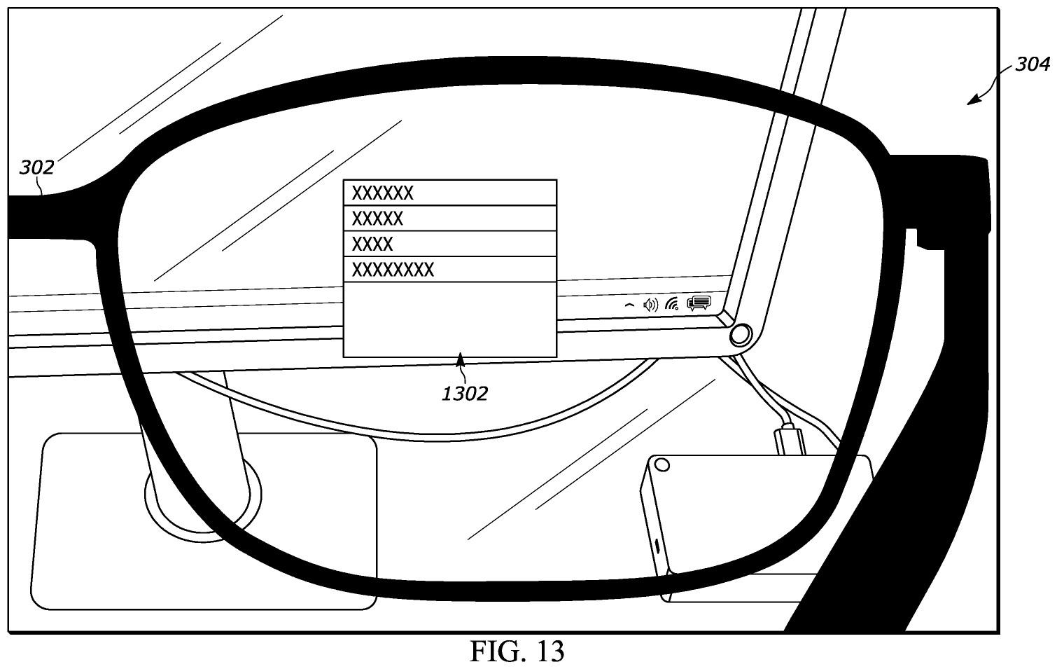

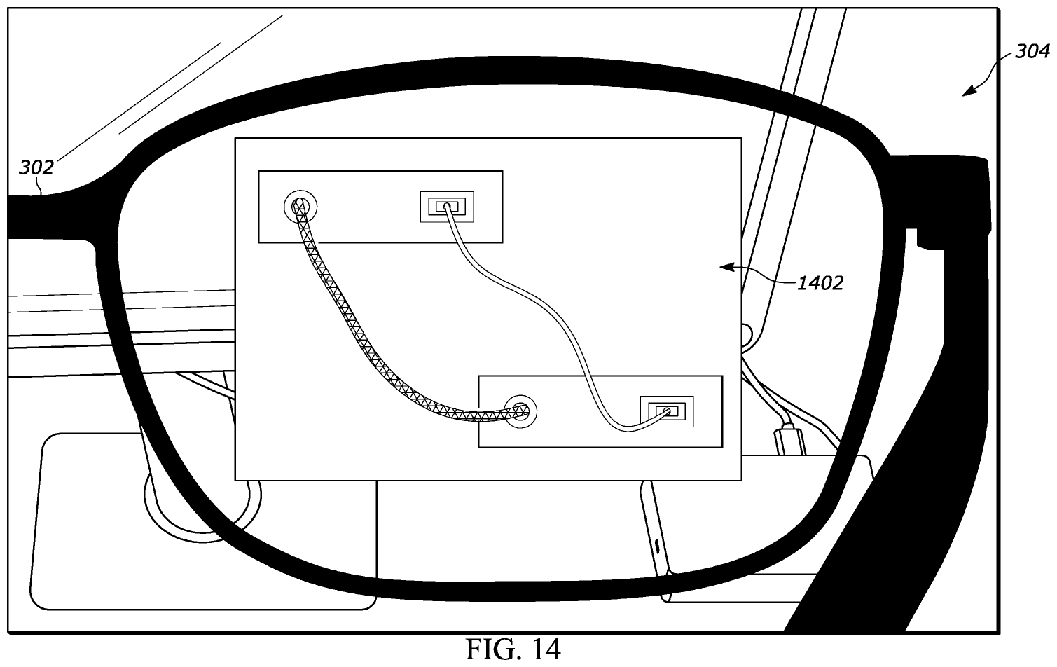

In other examples, overlaid, superimposed installation, trouble shooting, frequently asked questions (FAQ) information 1302 is overlaid, superimposed, etc. on the real world content 304 (see FIG. 13). In still further examples, a connection diagram 1402 (e.g., showing which cables are to be connected where) are overlaid, superimposed, etc. on the real world content 304 to assist, guide the user 108 in properly connecting the components C1, C2, G, etc. (see FIG. 14). In some examples, rather than overlaying or superimposing, the real world content 304 is displayed for one eye of the user 108, and the information 306-317 is displayed for the other eye of the user 108 using a binocular presentation.

In some examples, the real world content 304 is obtained via one or more cameras, image sensors, etc. (e.g., for a goggle based HMD), obtained by visual sight through, e.g., glass (e.g., for smart glasses), etc.

In some examples, the overlaid, superimposed information relates to a network, mesh, etc. of Internet of Things (IoT) devices such that user 108 can see where IoT devices are located (e.g., in a map, diagram of locations, etc.) and/or the status of such IoT devices enabling the user 108 to install and/or troubleshoot the IoT network, mesh, etc.

FIG. 15 illustrates a block diagram of an example HMD 1500 that may be used to implement the example HMD 102 of FIG. 1 and configured for use in installing or troubleshooting systems, such as the communication system 104. The HMD 1500 includes a display 1502, which is used to present an AR representation of a real world environment to a user (e.g., installation or configuration information presented over the real world environment). The HMD 1500 also includes a speaker 1504, which may be used to present audible instructions, which may include live instructions from a remote assistant or instructor, prerecorded instructions, or computer-generated speech instructions, along with other sounds. The HMD 1500 likewise includes an input 1508 to receive user input from the user, which may include user interactions with the AR environment, in some embodiments. Each of the display 1502, speaker 1504, or input 1508 may be integrated into the HMD 1500 or may be communicatively connected thereto.

The display 1502 may include any known or hereafter developed visual or tactile display technology, including smart glasses, goggles, retina projectors, LCD, OLED, AMOLED, projection displays, refreshable braille displays, haptic displays, or other types of displays. The one or more speakers 1504 may similarly include any controllable audible output device or component. In some embodiments, communicatively connected speakers 1504 may be used (e.g., headphones, Bluetooth headsets, docking stations with additional speakers, etc.). The input 1508 may further receive information from the user. Such input 1508 may include a physical or virtual keyboard, a microphone, virtual or physical buttons or dials, or other means of receiving information. In some embodiments, the display 1502 may include a touch screen or otherwise be configured to receive input from a user, in which case the display 1502 and the input 1508 may be combined.

The HMD 1500 further includes a controller 1510. The controller 1510 receives, processes, produces, transmits, and stores data. The controller 1510 may include a program memory 1512, one or more microcontrollers or microprocessors (MP) 1514, a random access memory (RAM) 1516, and an I/O circuit 1518. The components of the controller 1510 may be interconnected via an address/data bus or other means. It should be appreciated that although FIG. 15 depicts only one microprocessor 1514, the controller 1510 may include multiple microprocessors 1514 in some embodiments.

The memory of the controller 1510 may include multiple RAMs 1516 and multiple program memories 1512. Although the FIG. 15 depicts the I/O circuit 1518 as a single block, the I/O circuit 1518 may include a number of different I/O circuits, which may be configured for specific I/O operations. The microprocessor 1514 may include one or more processors of any known or hereafter developed type, including general-purpose processors or special-purpose processors. Example memories that may be used to implement the memories 1512 and/or 1516 include any number or type(s) of volatile or non-volatile non-transitory computer- or machine-readable storage medium or disk, such as a semiconductor memories, magnetically readable memories, optically readable memories, hard disk drive (HDD), an optical storage drive, a solid-state storage device, a solid-state drive (SSD), a read-only memory (ROM), a random-access memory (RAM), a compact disc (CD), a compact disc read-only memory (CD-ROM), a digital versatile disk (DVD), a Blu-ray disk, a redundant array of independent disks (RAID) system, a cache, a flash memory, or any other storage device or storage disk in which information may be stored for any duration (e.g., permanently, for an extended time period, for a brief instance, for temporarily buffering, for caching of the information, etc.).

As used herein, the term non-transitory computer-readable medium is expressly defined to include any type of computer-readable storage device and/or storage disk and to exclude propagating signals and to exclude transmission media. As used herein, the term non-transitory machine-readable medium is expressly defined to include any type of machine-readable storage device and/or storage disk and to exclude propagating signals and to exclude transmission media.

The program memory 1512 may include an operating system 1520, a data storage 1522, and a plurality of software applications or routines 1530. The operating system 1520, for example, may include one of a plurality of mobile platforms such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage 1522 may include data such as user profiles and preferences, application data for the plurality of applications 1530, and other data necessary to interact with the components of the communication system 104, the intermediary device 118, the server(s) 110 and/or the data store(s) 112 through the network 116. In some embodiments, the controller 1510 may also include, or otherwise be communicatively connected to, other data storage mechanisms (e.g., one or more hard disk drives, optical storage drives, solid state storage devices, etc.).

The software applications and routines 1530 may include computer-readable instructions that cause the processor 1514 to implement various functions of AR based installation and/or troubleshooting sessions, as described herein. Thus, the software applications 1530 may include an AR application 1532 to present an AR environment to a user, a communication application 1534 to send and receive real-time communication with one or more components of the communication system 104, the intermediary device 118, the server 110 and/or the data store 112 through the network 116.

The HMD 1500 may include one or more sensors 1550, which may provide sensor data regarding a local physical environment in which the HMD 1500 is operating. Sensor data may be processed by the controller 1510 to facilitate user interaction with an AR environment, as discussed elsewhere herein. Additionally, or alternatively, the sensor data may be sent to the server(s) 110 and/or the data store(s) 112 through the network 116 for processing. For clarity of illustration, not all conceivable sensors are shown in FIG. 15. Additionally, other types of currently available or later-developed sensors may be included in some embodiments. In the illustrated example of FIG. 15, an accelerometer 1552 is configured to position the HMD 1500 within its local physical environment, which may be used for navigating within a real world environment. A camera 1554 is configured to capture real world content, scan an indicia, QR code, marking, etc.) A microphone 1556 is configured to capture spoken commands and/or facilitate a telephone call or teleconference. A GPS device 1558 is configured to locate the HMD 1500 at an installation site or elsewhere.

The HMD 1500 may also communicate with the server 110, the data store 112, or other components of the communication system 104 via the network 116. Such communication may involve a communication unit 1540, which may manage communication between the controller 1510 and external devices (e.g., network components of the network 116, etc.). The communication unit 1540 may further transmit and receive wired or wireless communications with external devices, using any suitable wireless communication protocol network, such as a wireless telephony network (e.g., GSM, CDMA, LTE, etc.), a Wi-Fi network (802.11 standards), a WiMAX network, a Bluetooth network, etc. Additionally, or alternatively, the communication unit 1540 may also be capable of communicating using a near field communication standard (e.g., ISO/IEC 18092, standards provided by the NFC Forum, etc.). Furthermore, the communication unit 1540 may provide input signals to the controller 1510 via the I/O circuit 1518. The communication unit 1540 may also transmit sensor data, device status information, control signals, or other output from the controller 1510 to the server(s) 110, the data store(s) 112, and/or other devices via the network 130.

In some embodiments, the HMD 1500 may include a wearable computing device or may be communicatively connected to a wearable computing device. In such embodiments, part or all of the functions and capabilities of the HMD 1500 may be performed by or disposed within the wearable computing device. Additionally, or alternatively, the wearable computing device may supplement or complement the HMD 1500. For example, the HMD 1500 may be connected to a smart watch. Additionally or alternatively, the HMD 1500 may include or be communicatively connected to a control device, such as a mobile computing device (e.g., a smartphone, notebook computer, or digital assistant device). Such communicative connections may be used to expand the functionality of the HMD 1500 by providing additional computing resources, sensors, input components, or output components.

Example augmented reality head mounted displays and methods of operating the same for installing and troubleshooting systems are disclosed herein. Further examples and combinations thereof include at least the following.

Example 1 is a head-mounted display (HMD) configured to be worn by an installer includes: a display; a communication interface; a processor; and a non-transitory computer-readable medium storing computer-readable instructions. The instructions, when executed by the processor, cause the HMD to access, via the communication interface, first installation status information from a first component of a system at an installation site, and present, on the display, an augmented reality environment including the first installation status information and real world content.

Example 2 is the HMD of example 1, further comprising a communication interface to communicatively couple the HMD to the first component.

Example 3 is the HMD of example 2, wherein the HMD is communicatively coupled to the first component via a second component.

Example 4 is the HMD of example 2, wherein the communication interface includes a short range wireless interface.

Example 5 is the HMD of any of examples 1 to 4, wherein the real world content includes a field of view of the installer.

Example 6 is the HMD of any of examples 1 to 5, further comprising an imaging device, and wherein the computer-readable instructions, when executed by the processor, further cause the HMD to obtain an indicia on the first component from the imaging device, obtain configuration information related to at least one of the first component or the installation site system based on a payload of the indicia, and present, on the display, the configuration information.

Example 7 is the HMD of example 6, wherein the configuration information includes configuration parameters for at least one of the first component or a second component of the communication system.

Example 8 is the HMD of any of examples 1 to 7, wherein the first installation status information includes field diagnostic information.

Example 9 is the HMD of any of examples 1 to 8, wherein the computer-readable instructions, when executed by the processor, further cause the HMD to access second installation status information from a server connected to the communication system, wherein the second installation status information relates to a status of a connection between a provider system and the communication system, and present, on the display, the second installation status information.

Example 10 is the HMD of example 9, wherein the second installation status information includes field diagnostic information.

Example 11 is the HMD of any of examples 1 to 10, wherein the computer-readable instructions, when executed by the processor, further cause the HMD to display information instead of the augmented reality presentation for one eye of the installer.

Example 12 is the HMD of any of examples 1 to 11, wherein the computer-readable instructions, when executed by the processor, further cause the HMD to obtain status information from a plurality of Internet of Things (IoT) devices, and present, on the display, a diagram of locations of the IoT devices.

Example 13 is the HMD of any of examples 1 to 12, wherein the computer-readable instructions, when executed by the processor, further cause the HMD to present installation information for components of the communication system.

Example 14 is a method of operating a head mounted display (HMD), the method comprising: accessing, via a communication interface of an HMD configured to be worn by an user at an installation site, first installation status information from a first component of a communication system at an installation site; obtaining, by the HMD real world content; and presenting an augmented reality environment including the first installation status information and the real world content.

Example 15 is the method of example 14, further comprising: obtaining an indicia on the first component from the imaging device; obtaining configuration information related to at least one of the first component or the installation site system based on a payload of the indicia; and presenting the configuration information in the augmented reality environment.

Example 16 is the method of example 14 or example 15, wherein the configuration information includes configuration parameters for at least one of the first component or a second component of the communication system.

Example 17 is the method of any of examples 14 to 16, further comprising: accessing second installation status information from a server connected to the communication system, wherein the second installation status information relates to a status of a connection between a provider system and the communication system; and presenting the second installation status information in the augmented reality environment.

Example 18 is the method of any of examples 14 to 17, further comprising: obtaining status information from a plurality of Internet of Things (IoT) devices; and presenting a diagram of locations of the IoT devices in the augmented reality environment.

Example 19 is the method of any of examples 14 to 18, further comprising presenting installation information for components of the communication system in the augmented reality environment.

Example 20 is a non-transitory computer-readable storage medium comprising instructions that, when executed, cause a head mounted display (HMD) to, while being used at an installation site: access first installation status information from a first component of a communication system; and present an augmented reality environment including the first installation status information and real world content.

This detailed description is to be construed as example only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for systems and methods according to the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the techniques disclosed herein without departing from the spirit and scope defined in the appended claims.

Although individual operations of one or more methods are illustrated and described as separate operations, one or more of the individual operations may be performed concurrently, and nothing requires that the operations be performed in the order illustrated. Structures and components presented as separate components in example configurations may be implemented as a combined structure or component. Similarly, structures and components presented as a single component may be implemented as separate components. These and other variations, modifications, additions, and improvements fall within the scope of the subject matter herein.

To the extent that any term recited in the claims at the end of this disclosure is referred to in this disclosure in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Use of “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise. A device or structure that is “configured” in a certain way is configured in at least that way, but may also be configured in ways that are not listed.

Further, as used herein, the expressions “in communication,” “coupled” and “connected,” including variations thereof, encompasses direct communication and/or indirect communication through one or more intermediary components, and does not require direct mechanical or physical (e.g., wired) communication and/or constant communication, but rather additionally includes selective communication at periodic intervals, scheduled intervals, aperiodic intervals, and/or one-time events. The embodiments are not limited in this context.

Further still, unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

Moreover, in the foregoing specification, specific embodiments have been described. However, one of ordinary skill in the art appreciates that various modifications and changes can be made in view of aspects of this disclosure without departing from the scope of the invention as set forth in the claims below. Accordingly, the specification and figures are to be regarded in an illustrative rather than a restrictive sense, and all such modifications made in view of aspects of this disclosure are intended to be included within the scope of present teachings.

Additionally, the benefits, advantages, solutions to problems, and any element(s) that may cause any benefit, advantage, or solution to occur or become more pronounced are not to be construed as a critical, required, or essential features or elements of any or all the claims.

What is claimed is:

1. A head-mounted display (HMD) configured to be worn by an installer, the HMD comprising:
a display;
a communication interface;
a processor; and
a non-transitory computer-readable medium storing computer-readable instructions that, when executed by the processor, cause the HMD to
access, via the communication interface, first installation status information from a first component of a communication system at an installation site, and
present, on the display, an augmented reality environment including the first installation status information and real world content.

2. The HMD of claim 1, further comprising a communication interface to communicatively couple the HMD to the first component.

3. The HMD of claim 2, wherein the HMD is communicatively coupled to the first component via a second component.

4. The HMD of claim 2, wherein the communication interface includes a short range wireless interface.

5. The HMD of claim 1, wherein the real world content includes a field of view of the installer.

6. The HMD of claim 1, further comprising an imaging device, and wherein the computer-readable instructions, when executed by the processor, further cause the HMD to
obtain an indicia on the first component from the imaging device,
obtain configuration information related to at least one of the first component or the installation site system based on a payload of the indicia, and
present, on the display, the configuration information.

7. The HMD of claim 6, wherein the configuration information includes configuration parameters for at least one of the first component or a second component of the communication system.

8. The HMD of claim 1, wherein the first installation status information includes field diagnostic information.

9. The HMD of claim 1, wherein the computer-readable instructions, when executed by the processor, further cause the HMD to
access second installation status information from a server connected to the communication system, wherein the second installation status information relates to a status of a connection between a provider system and the communication system, and
present, on the display, the second installation status information.

10. The HMD of claim 9, wherein the second installation status information includes field diagnostic information.

11. The HMD of claim 1, wherein the computer-readable instructions, when executed by the processor, further cause the HMD to display information instead of the augmented reality presentation for one eye of the installer.

12. The HMD of claim 1, wherein the computer-readable instructions, when executed by the processor, further cause the HMD to
obtain status information from a plurality of Internet of Things (IoT) devices, and
present, on the display, a diagram of locations of the IoT devices.

13. The HMD of claim 1, wherein the computer-readable instructions, when executed by the processor, further cause the HMD to present installation information for components of the communication system.

14. A method of operating a head mounted display (HMD), the method comprising:
accessing, via a communication interface of an HMD configured to be worn by an user at an installation site, first installation status information from a first component of a communication system at an installation site;
obtaining, by the HMD real world content; and
presenting an augmented reality environment including the first installation status information and the real world content.

15. The method of claim 14, further comprising:
obtaining an indicia on the first component from the imaging device;
obtaining configuration information related to at least one of the first component or the installation site system based on a payload of the indicia; and
presenting the configuration information in the augmented reality environment.

16. The method of claim 14, wherein the configuration information includes configuration parameters for at least one of the first component or a second component of the communication system.

17. The method of claim 14, further comprising:
accessing second installation status information from a server connected to the communication system, wherein the second installation status information relates to a status of a connection between a provider system and the communication system; and
presenting the second installation status information in the augmented reality environment.

18. The method of claim 14, further comprising:
obtaining status information from a plurality of Internet of Things (IoT) devices; and
presenting a diagram of locations of the IoT devices in the augmented reality environment.

19. The method of claim 14, further comprising presenting installation information for components of the communication system in the augmented reality environment.

20. A non-transitory computer-readable storage medium comprising instructions that, when executed, cause a head mounted display (HMD) to, while being used at an installation site:
access first installation status information from a first component of a communication system; and
present an augmented reality environment including the first installation status information and real world content.
